(19) United States
(12) Patent Application Publication
(10) Pub. No.: US 2019/0055505 A1
(43) Pub. Date: Feb. 21, 2019

(54) UNCLE BINGOS FAMOUS JAMAICAN RUM PUNCH

(71) Applicant: Patrick George, Brooklyn, NY (US)

(72) Inventor: Patrick George, Brooklyn, NY (US)

(21) Appl. No.: 16/105,969

(22) Filed: Aug. 21, 2018

Related U.S. Application Data
(60) Provisional application No. 62/548,313, filed on Aug. 21, 2017.

(51) Int. Cl. C12G 3/06; A23L 2/02

(52) U.S. Cl. CPC C12G 3/06; A23V 2002/00; A23L 2/02

(57) ABSTRACT

A mix of the finest Jamaican white rum and all-natural juices to provide a delicious new spirit selection that renders a traditional West Indian tradition a universal favorite.

### CROSS-REFERENCE TO RELATED APPLICATION

The present application is related to and claims priority from prior provisional application Ser. No. 62/548,313, filed Aug. 21, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### FIELD OF THE INVENTION

The present invention relates generally to the field of beverages and more specifically relates to a specially formulated recipe for an alcoholic beverage comprising a mix of the finest Jamaican white rum and all-natural juices to provide a delicious new spirit selection that renders a traditional West Indian tradition a universal favorite.

### DESCRIPTION OF THE RELATED ART

Whether sharing a beer with friends down at the neighborhood bar or savoring the taste of a smooth red wine with dinner, many adult consumers enjoy alcoholic beverages. Moderate alcohol consumption can be broadly defined as the level of drinking that has a low risk of alcohol-related problems, for both the drinker and others. In fact, recent research shows that the moderate use of alcohol is related with reduced risk of several diseases. The most compelling evidence supports the relationship between moderate drinking and reduced risk of coronary heart disease. In addition, moderate alcohol consumption has also been associated with decreased risk of peripheral arterial disease, ischemic stroke, and Type 2 diabetes mellitus. For those who drink responsibly, the health benefits of alcohol can combine with the savory taste of a chosen beverage to offer these consumers a positive indulgence.

Ideally, an alcoholic beverage comprising a mix should be user-friendly and safe in-use and, yet would operate reliably and be manufactured at a modest expense. Thus, a need exists for a specially formulated recipe for an alcoholic beverage comprising a mix of the finest Jamaican white rum and all-natural juices to provide a delicious new spirit selection that renders a traditional West Indian tradition a universal favorite and to avoid the above-mentioned problems.

### BRIEF SUMMARY OF THE INVENTION

In view of the foregoing disadvantages inherent in the known of beverages art, the present invention provides a novel specially formulated recipe for an alcoholic beverage (Entitled Uncle Bingos Famous Jamaican Rum Punch). The general purpose of the present invention, which will be described subsequently in greater detail is to provide a specially formulated recipe for an alcoholic beverage comprising a mix of the finest Jamaican white rum and all-natural juices to provide a delicious new spirit selection that renders a traditional West Indian tradition a universal favorite

An alcoholic beverage comprising a mix of: rum; orange juice; pineapple juice; pineapple syrup; coconut syrup; and lime juice. Wherein the rum is Wray and Nephew Overproof Jamaican White Rum. Wherein said orange juice is Tree Ripe Orange Juice. Wherein said pineapple juice is Dole Pineapple Juice. Wherein the pineapple syrup is Torani Pineapple Syrup. Wherein the coconut syrup is Torani Coconut Syrup. Wherein the lime juice is Jamaica Choice Lime Juice.

Wherein the mix of the rum; the orange juice; the pineapple juice; the pineapple syrup; the coconut syrup; and the lime juice, is formed with the following quantities: 1.75 liters of rum; 59 ounces of orange juice; 46 ounces of pineapple juice; 24.6 ounces of pineapple syrup; 24.6 ounces of coconut syrup; and 16 ounces of lime juice.

The present invention holds significant improvements and serves as a Uncle Bingos Famous Jamaican Rum Punch. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, an alcoholic beverage comprising a mix (Entitled Uncle Bingos Famous Jamaican Rum Punch) constructed and operative according to the teachings of the present invention.

FIG. 1A shows a perspective view illustrating a front view of a beverage container storing Uncle Bingos Famous Jamaican Rum Punch according to an embodiment of the present invention.

FIG. 1B shows a perspective view illustrating a back view of a beverage container storing Uncle Bingos Famous Jamaican Rum Punch according to an embodiment of the present invention.

FIG. 2 is a flowchart illustrating ingredients found in alcoholic beverage comprising a mix of the Uncle Bingos Famous Jamaican Rum Punch according to an embodiment of the present invention of FIG. 1.

FIG. 3 is a flowchart illustrating specific amounts of the ingredients found in alcoholic beverage comprising a mix of the Uncle Bingos Famous Jamaican Rum Punch according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a beverage device and more particularly to an alcoholic beverage (Entitled Uncle Bingos Famous Jamaican Rum Punch) comprising a mix of the finest Jamaican white rum and all-natural juices to provide a delicious new spirit selection that renders a traditional West Indian tradition a universal favorite.

Generally speaking, Uncle Bingos Famous Jamaican Rum Punch comprises a specially designed unique new alcoholic beverage that is healthy and contains a flavorful edge over standard offerings, Mr. Patrick George has conceived a creative product he has designated Uncle Bingo's Famous Jamaican Rum Punch. Simply stated, this line is a specially formulated spirit comprised of ingredients that combine all-natural fruit juices with a top-shelf Jamaican white rum.

Specially formulated spirit comprised of ingredients that combine all-natural fruit juices with a top-shelf Jamaican white rum, and presented as a recipe, Uncle Bingo's Famous Jamaican Rum Punch would contain the following formula:

### 1. Loco Coco

1 Tree Ripe Orange Juice 59 oz.
1 Dole Pineapple Juice 46 oz
1 Bottle of Torani Pineapple Syrup 24.6 oz
1 Torani Coconut Syrup 24.6 oz
16 oz Jamaica Choice Lime Juice
1.75 Liter Wray and Nephew Overproof Jamaican White Rum

### 2. Pineapple Passion

1 Tree Ripe Orange Juice 59 oz.
1 Dole Pineapple Juice 46 oz
2 Bottles of Torani Pineapple Syrup 24.6 oz each bottle
16 oz Jamaica Choice Lime Juice
1.75 Liter Wray and Nephew Overproof Jamaican White Rum

### 3. Kiwi Strawberry Delight

1 Tree Ripe Orange Juice 59 oz.
40 oz Tree Ripe Orange Juice
1 Torani Strawberry Syrup 24.6 oz
1 Torani Kiwi Syrup 24.6 oz
16 oz Jamaica Choice Lime Juice
1.75 Liter Wray and Nephew Overproof Jamaican White Rum

### 4. Peach on the Beach

1 Tropican Peach Orchard Punch 59 oz
40 oz Tree Ripe Orange Juice
2 Bottles of Torani Peach Syrup at 24.6 oz per bottle
16 oz Jamaica Choice Lime Juice
1.75 Liter Wray and Nephew Overproof Jamaican White Rum

### 5. Skip to My Lue Blue Curacou

1 Tree Ripe Orange Juice 59 oz.
40 oz Tree Ripe Orange Juice
2 Bottles of Torani Blue Curacou Syrup at 24.6 oz each bottle
16 oz Jamaica Choice Lime Juice
1.75 Liter Wray and Nephew Overproof Jamaican White Rum

### 6. Curios Apple Orchard

1 Juicy Apple Juice 59 oz
40 oz Juicy Juice Apple Juice
2 Bottles of Torani Apple Syrup at 24.6 oz each bottle
16 oz Jamaica Choice Lime Juice
1.75 Liter Wray and Nephew Overproof Jamaican White Rum

### 7. Mango Tango

1 Earthwise Mango Carrot Juice 59 oz.
40 oz, Tree Ripe Orange Juice
2 Bottles of Torani Mango Syrup at 24.6 oz each bottle
16 oz Jamaica Choice Lime Juice
1.75 Liter Wray and Nephew Overproof Jamaican White Rum

### 8. In Time Cherry Lime

1 Minute-Maid Cherry/Lime Juice 59 oz
40 oz, Tree Ripe Orange Juice
2 Bottles of Torani Cherry/Lime Syrup at 24.6 oz each bottle
16 oz Jamaica Choice Lime Juice
1.75 Liter Wray and Nephew Overproof Jamaican White Rum

### 9. Mean Green Apple

1 Welch's White Apple Juice 59 oz
40 oz, Welch's White Apple Juice
2 Bottles of Torani Green Apple Syrup 24.6 oz each bottle
16 oz Jamaica Choice Lime Juice
1.75 Liter Wray and Nephew Overproof Jamaican White Rum

### 10. Rola Kola Champagne

1 Tree Ripe Orange Juice 59 oz
40 oz, Tree Ripe Orange Juice
2 Bottles of Torani Grace Kola Champagne Syrup at 24.6 oz each bottle
16 oz Jamaica Choice Lime Juice
1.75 Liter Wray and Nephew Overproof Jamaican White Rum

### 11. Pure Fun Butter Rum

1 Tree Ripe Orange Juice 59 oz
40 oz, Tree Ripe Orange Juice
2 Bottles of Torani Butter Rum Syrup at 24.6 oz each bottle
16 oz Jamaica Choice Lime Juice
1.75 Liter Wray and Nephew Overproof Jamaican White Rum

### 12. Be Merry Raspberry

1 Tropicana Fruit Punch Juice 59 oz
40 oz, Tree Ripe Orange Juice
2 Bottles of Torani Raspberry Syrup at 24.6 oz each bottle
16 oz Jamaica Choice Lime Juice
1.75 Liter Wray and Nephew Overproof Jamaican White Rum
   When each formula is mixed in a circular cooler, using the measurements that are listed, it will yield the following amounts:
1—Close to four 1.75 Liter Bottles
2—Close to twelve to twelve and a half 16 oz, bottles

It is the intention of Uncle Bingo's Famous Jamaican Rum Punch to parlay a legendary spirit into a universally savored new cocktail, enhancing common Jamaican rum punch into an authentic yet fresh new beverage offering. Upon development, this product would be offered for public sale in three (3) bottle sizes: twelve (12) ounces, sixteen (16) ounces, and in 1.75-liter bottles. As an additional consideration, Uncle Bingo's Famous Jamaican Rum Punch could be offered in decorative, collectible bottles that can be artfully displayed after use.

Uncle Bingo's Famous Jamaican Rum Punch would offer adult consumers a delicious tasting new line of cocktails that contain none of the additives or effects of existing cocktails. Creatively blending the best Jamaican white rum along with all-natural fruit juices sharing space a variety of syrup flavorings, also all-natural, this clever drink would provide an alternative to standard alcoholic varieties that tend to be loaded with sugars and leave one with a blistering hangover the next day. With Uncle Bingo's Famous Jamaican Rum Punch, a drinker concerned with his or her health would be able to freely enjoy a responsible amount of this beverage without worry of detrimental effects. Offering a variety of tastes ranging from soft to searing, this cocktail is sure to appeal to virtually an liquor connoisseur.

Whether one wishes to indulge in sweetness while entertaining friends, something tangy to unwind after a hectic day, or something smooth to cleanse the palate after dinner, a chosen variety of Uncle Bingo's Famous Jamaican Rum Punch would be appropriate for any occasion. Uncle Bingo's Famous Jamaican Rum Punch would offer an effective blending of style, taste, and health-consciousness to the world of alcoholic beverages. Sold with creative, eye-catching packaging, this beverage line would be perfect for use at parties or to simply display in a household liquor cabinet.

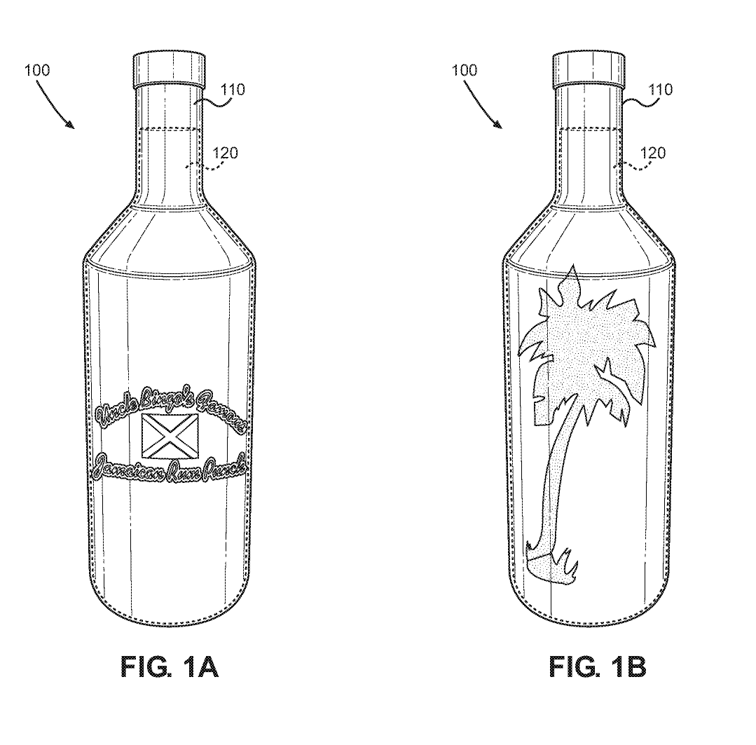

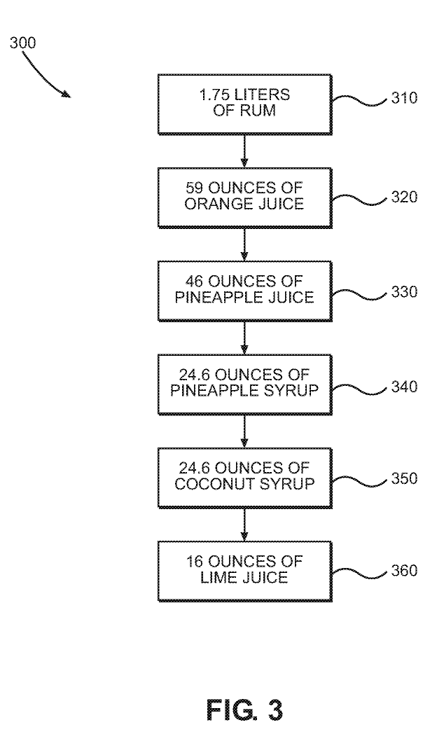

Referring to the drawings by numerals of reference there is shown in FIGS. 1-3, perspective views illustrating molding system 100 for forming snowman 200 according to an embodiment of the present invention.

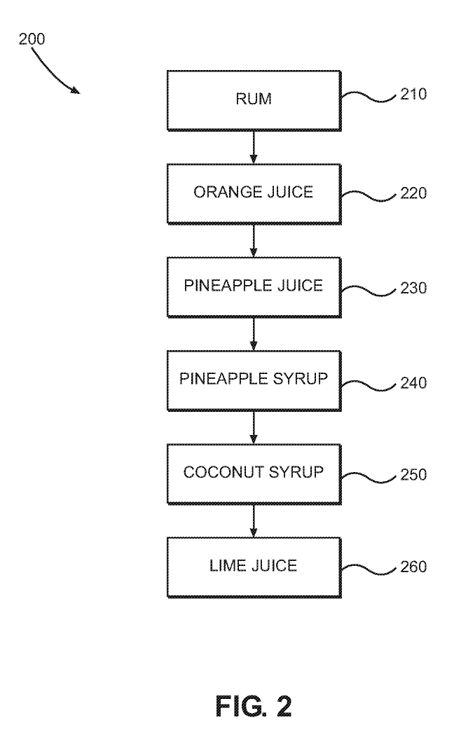

Alcoholic beverage 100 stored in beverage container 110 comprising mix 120 store in beverage container 110 as shown in FIG. 1 of: rum 210; orange juice 220; pineapple juice 230; pineapple syrup 240; coconut syrup 250; and lime juice 260 as shown in Flowchart 200 of FIG. 2. Wherein rum 210 is Wray and Nephew Overproof Jamaican White Rum. Wherein orange juice 220 is Tree Ripe Orange Juice. Wherein pineapple juice 230 is Dole Pineapple Juice. Wherein pineapple syrup 240 is Torani Pineapple Syrup. Wherein coconut syrup 250 is Torani Coconut Syrup. Wherein lime juice 260 is Jamaica Choice Lime Juice.

Wherein mix 120 of rum 210; orange juice 220; pineapple juice 230; pineapple syrup 240; coconut syrup 250; and lime juice 260, is formed with the following quantities: 1.75 liters of rum 310; 59 ounces of orange juice 320; 46 ounces of pineapple juice 330; 24.6 ounces of pineapple syrup 340; 24.6 ounces of coconut syrup 350; and 16 ounces of lime juice 360 as shown in Flowchart 300.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. An alcoholic beverage comprising a mix of:
rum;
orange juice;
pineapple juice;
pineapple syrup;
coconut syrup; and
lime juice.

2. The alcoholic beverage of claim 1, wherein said rum is Wray and Nephew Overproof Jamaican White Rum.

3. The alcoholic beverage of claim 1, wherein said orange juice is Tree Ripe Orange Juice.

4. The alcoholic beverage of claim 1, wherein said pineapple juice is Dole Pineapple Juice.

5. The alcoholic beverage of claim 1, wherein said pineapple syrup is Torani Pineapple Syrup.

6. The alcoholic beverage of claim 1, wherein said coconut syrup is Torani Coconut Syrup.

7. The alcoholic beverage of claim 1, wherein said lime juice is Jamaica Choice Lime Juice.

8. The alcoholic beverage of claim 1, wherein said mix of said rum; said orange juice; said pineapple juice; said pineapple syrup; said coconut syrup; and said lime juice, is formed with the following quantities:
1.75 liters of rum;
59 ounces of orange juice;
46 ounces of pineapple juice;
24.6 ounces of pineapple syrup;
24.6 ounces of coconut syrup; and
16 ounces of lime juice.
